(19) United States
(12) Patent Application Publication
(10) Pub. No.: US 2026/0008438 A1
(43) Pub. Date: Jan. 8, 2026

(54) NOZZLE FOR AUTOMATIC CLEANING OF A SENSOR

(71) Applicant: A. RAYMOND ET CIE, Grenoble (FR)

(72) Inventors: Jan Regensburger, Kandern (DE); Thomas Grathwol, Schliengen (DE)

(21) Appl. No.: 19/123,629

(22) PCT Filed: Oct. 22, 2024
(86) PCT No.: PCT/EP2024/079860

§ 371 Date: Apr. 23, 2025

(30) Foreign Application Priority Data
Nov. 7, 2023 (DE) 102023130809.2

(51) Int. Cl. B60S 1/56; B60S 1/52

(52) U.S. Cl. CPC B60S 1/56; B60S 1/52

(57) ABSTRACT

A nozzle for the automatic cleaning of a sensor, in particular a sensor of a motor vehicle, includes an outlet for dispensing the fluid, and a flat surface. The flat surface is arranged on the inner surface of the nozzle. The outlet is arranged in the flat surface. The flat surface includes two opposing sides and an upper side. The upper side is arranged between the two opposing sides. The nozzle further includes two curved surfaces on the inner surface. Each of the curved surfaces is arranged on each of the two opposing sides of the flat surface, and the curved surfaces are configured such that they converge towards one another in the direction of the upper side.

### FIELD OF THE INVENTION

The invention relates to a nozzle for the automatic cleaning of a sensor, in particular a sensor of a motor vehicle.

### STATE OF THE ART

A nozzle for the automatic cleaning of a sensor, in particular a sensor of a motor vehicle, is regularly found in vehicles. The nozzle is used to clean a sensor. Alternatively, the nozzle can also be used to clean a headlight.

The sensor is becoming increasingly important as a support for the driver, for semi-autonomous driving or for autonomous driving. The sensor can be, for example, a radar sensor, a lidar (Light detection and ranging) sensor or an ultrasonic sensor. By means of the sensor, a motor vehicle can, for example, collect information about its surroundings and based on this, support the driver or act autonomously. For example, a sensor is used for autonomous driving, for adaptive cruise control, for parking assistance or for automatic parking.

However, dirt accumulates on the sensor during use, for example while the motor vehicle is in motion. The dirt impairs the function of the sensor, so that, for example, no distance measurements can be collected for semi-autonomous driving, autonomous driving or automatic parking. Thus, due to the dirt on the sensor, the vehicle can no longer support the driver and can no longer operate autonomously.

Therefore, the dirt must be removed from the sensor regularly and as completely as possible. A nozzle is used for this purpose. A fluid is applied to the sensor using the nozzle. This way, the dirt can be softened and washed away with the fluid. However, large quantities of fluid such as water are required for this.

In addition, persistent dirt, for example from insects on the sensor, cannot be softened and washed away with the fluid. This means that the persistent dirt must be removed by the driver of the vehicle by hand. To do this, the vehicle must first be driven to a cleaning station, such as a petrol station, to carry out the cleaning. On the one hand, this is very time-consuming. On the other hand, if the sensor is already dirty, the driver can no longer rely on the sensor for the drive to the cleaning station.

Based on this state of the art, the object of the present invention is to provide a nozzle that can be used to remove dirt, and in particular persistent dirt, reliably, easily and thoroughly, while the nozzle exhibits low fluid consumption and is therefore very efficient.

### SUMMARY OF THE INVENTION

The above-mentioned task is solved in accordance with a first aspect of the invention by means of a nozzle for the automatic cleaning of a sensor, in particular a sensor of a motor vehicle, wherein the nozzle comprises an outlet for dispensing the fluid, wherein the nozzle comprises a flat surface, wherein the flat surface is arranged on the inner surface of the nozzle, wherein the outlet is arranged in the flat surface, wherein the flat surface comprises two opposing sides, the flat surface comprises an upper side, wherein the upper side is arranged between the two opposing sides, wherein the nozzle comprises two curved surfaces on the inner surface, wherein each of the curved surfaces is arranged on one of the two opposing sides of the flat surface, wherein the curved surfaces are configured such that they converge towards one another in the direction of the upper side.

This makes it particularly easy and reliable for the nozzle to remove dirt, especially from a sensor. The nozzle can also be used to easily remove even persistent dirt, ensuring simple, reliable and thorough removal of dirt. Above all, the nozzle is particularly efficient due to lower fluid consumption.

The nozzle may be configured to accelerate the fluid. The nozzle may be configured to spray the fluid. The nozzle may comprise an inlet for the receptacle of the fluid. The nozzle may be configured in particular to form at least three fluid jets. A fluid jet may exhibit a larger amount of fluid than the areas between the at least three fluid jets. In this way, a particularly simple, reliable and thorough removal of dirt can be ensured.

The fluid may be a liquid and/or a gas. The fluid may be, for example, air, water, water with a cleaning agent and/or water with an anti-freeze agent.

For the automatic cleaning of a sensor, this can mean that the sensor is cleaned without the intervention of a person. Thus, the nozzle can clean the sensor independently. The cleaning of the sensor can be triggered by the sensor itself and/or by a person, such as the driver of a motor vehicle.

The sensor can be, for example, a radar sensor, a lidar (Light detection and ranging) sensor, a camera or an ultrasonic sensor.

The outlet for dispensing the fluid can be a connection between the inside of the nozzle and the surroundings of the nozzle. The outlet can be designed in such a way that a sufficient amount of fluid can escape through the outlet. The outlet can be an opening in the nozzle. The outlet can, for example, be radially offset to the longitudinal axis or arranged along the longitudinal axis.

The flat surface may form a plane. The flat surface may be a surface described by two axes. In particular, the flat surface may not exhibit any curvature. The flat surface may extend two-dimensionally on the inner surface of the nozzle.

The flat surface is arranged on the inner surface of the nozzle. The inner surface of the nozzle can be the surface that can limit a fluid. The inner surface can conduct a fluid. The inner surface can form a closed space for guiding a fluid in the nozzle. The flat surface can be arranged radially to a centre axis of the nozzle. In particular, the flat surface can be parallel to the centre axis.

The outlet is arranged in the flat surface which can mean that the outlet is a recess in the flat surface that may extend from the inner surface to the outer surface of the nozzle. The outlet may be partially or completely surrounded by the flat surface.

The flat surface comprises two opposing sides. The sides of the surface may be the boundary of the flat surface. The opposing sides may be a line. The two opposing sides may limit the flat surface along a straight line between the two opposing sides. The opposing sides may at least partially limit the flat surface. In particular, the two opposing sides may be aligned parallel to one another. The two opposing sides can form an angle greater than 0° with each other. The two opposing sides can be mirror-symmetrical to a plane, wherein the plane passes through the flat surface, wherein, in particular, the plane is perpendicular to the flat surface. The two opposing sides can consist of several straight lines. Alternatively or additionally, the two opposing sides can exhibit a curvature.

The flat surface comprises an upper side. The upper side can be arranged along a direction of flow of a fluid in the nozzle behind a lower side of the flat surface. The upper side can be at the same height as the lower side. In particular, the upper side can be the side that can be arranged closer to the side of the outlet where a fluid can be deflected. The upper side can lie along the direction of the fluid on the outside of the deflected fluid. The upper side can be the side from which the fluid can be deflected. The upper side can consist of several straight lines. Alternatively or additionally, the upper side can exhibit a curvature.

The upper side is arranged between the two opposing sides. The upper side can connect the two opposing sides to each other. The upper side can be arranged at a distance from the two opposing sides so that the upper side cannot touch the two opposing sides. In particular, the upper side can be arranged between two ends of the two opposing sides.

The nozzle comprises two curved surfaces on the inner surface. The two curved surfaces can each exhibit a curvature. The two curved surfaces can form part of the inner surface. The two curved surfaces can cause the inside of the nozzle to taper. In particular, the two curved surfaces may be configured such that the two curved surfaces increase the static pressure on a fluid by reducing the space. In particular, the two curved surfaces may exhibit the same curvature and/or the same direction.

One of the curved surfaces is arranged on each of the two opposing sides of the flat surface. For example, one curved surface can be connected to one of the two opposing sides of the flat surface. The curved surfaces can be arranged on the flat surface, wherein the curved surfaces can be connected to the flat surface on the two opposing sides.

The curved surfaces are configured to converge towards each other in the direction of the upper side. The curved surfaces can, for example, cause the inside of the nozzle to taper in the direction of the upper side. For example, the distance between the two curved surfaces can become smaller in the direction of the upper side. In particular, the 40) two curved surfaces can also be configured to converge beyond the upper side. Thus, for example, the distance between the two curved surfaces can become smaller in the direction of the upper side, wherein the distance between the two curved surfaces can become even smaller beyond the upper side.

According to a first embodiment, the two curved surfaces can be connected via a centre plane, wherein the centre plane can be arranged on the upper side.

The centre plane is particularly effective at influencing the flow profile of the fluid. This means that the nozzle can guarantee the removal of dirt, and in particular persistent dirt, in a particularly reliable, simple, efficient and thorough manner.

The centre plane may exhibit curvature. The centre plane may be a surface described by two axes. In particular, the centre plane may not exhibit any curvature. The centre plane may extend in two dimensions on the inner surface of the nozzle.

The two curved surfaces can be connected via the centre plane. The centre plane can thus be arranged between the two curved surfaces and can be connected to each of the two curved surfaces. The width of the centre plane can vary. In particular, the width can be the distance between the two curved surfaces. For example, the width of the centre plane can become progressively smaller starting from the upper side, wherein the two curved surfaces can progressively converge towards one another starting from the upper side.

The centre plane can be arranged on the upper side. The centre plane can thus be arranged on the flat surface, wherein the centre plane can be connected in particular to the flat surface on the upper side. The centre plane can be at least partially limited by the two curved surfaces and the flat surface.

According to one embodiment, the centre plane can consist of at least two partial planes.

If the centre plane can consist of at least two partial planes, the exit speed of a fluid can be controlled advantageously. This means that the nozzle can be used to remove dirt and in particular persistent dirt particularly reliably, easily, efficiently and thoroughly.

The centre plane can consist of at least two partial planes. The at least two partial planes can be arranged directly next to each other. For example, the at least two partial planes can be arranged one behind the other starting from the upper side. In particular, each of the at least two partial planes can be connected to the two curved surfaces. The at least two partial planes can exhibit different sizes.

According to one embodiment, the curved surfaces may begin at the flat surface in the area where the outlet may be arranged in the flat surface.

In this way, the pressure on the fluid can be influenced and, for example, increased over the entire height of the outlet. This has the advantage of influencing the flow speed of the fluid, so that the nozzle can be used to remove dirt and in particular persistent dirt particularly reliably, easily, efficiently and thoroughly.

The curved surfaces can start at the flat surface in the area where the outlet can be arranged in the flat surface, which can mean that an imaginary line between the two curved surfaces passes through the outlet. For example, the two ends of the two curved surfaces can be connected by an imaginary line, wherein the imaginary line passes through the outlet.

According to one embodiment, the outlet may be rectangular, oval or crescent-shaped.

In this way, the profile of the outflowing fluid can be advantageously configured so that dirt and in particular persistent dirt can be removed particularly reliably, easily, efficiently and thoroughly.

Half-moon shaped can be semi-circular and/or in the shape of a crescent moon.

According to one embodiment, a point on each of the two curved surfaces may be spaced a maximum of 0.5 mm, preferably a maximum of 0.1 mm and particularly preferably a maximum of 0.05 mm from the outlet.

In this way, the flow profile of the outflowing fluid can be particularly favourably influenced by the curved surfaces at the outlet, so that dirt and in particular persistent dirt can be removed particularly reliably, easily, efficiently and thoroughly.

A point on each of the two curved surfaces may be spaced apart a maximum of 0.5 mm, preferably a maximum of 0.1 mm, and particularly preferably a maximum of 0.05 mm, from the outlet. The point on each of the two curved surfaces may be anywhere on each of the curved surfaces. The point may be the location on the curved surfaces that is arranged closest to the outlet. The point of each of the two curved surfaces may only be separated from the outlet by a maximum of 0.5 mm, preferably a maximum of 0.1 mm and, more preferably, a maximum of 0.05, by the flat surface.

According to one embodiment, the nozzle can extend along a centre axis, wherein the two curved surfaces can be arranged mirror-symmetrical to a mirror plane, wherein the mirror plane can contain the centre axis and the mirror plane can run through the outlet, in particular through the centre point of the outlet.

In this way, the jet created by the nozzle can be particularly uniform with the outflowing fluid, so that cleaning sensors can be particularly efficient, thorough, reliable and easy. If the mirror plane can pass through the centre of the outlet, cleaning is particularly efficient.

The centre axis can be the longitudinal axis of the nozzle. The centre axis can run through the centre of the nozzle.

The centre of the outlet can be the point with the maximum distance to all edges of the outlet.

According to one embodiment, the nozzle can comprise a protrusion on the outer surface, wherein the protrusion can be arranged on the region of the outlet facing the upper side.

In this way, at least one particularly hard spray jet can be generated with the nozzle. This can make cleaning of the sensor particularly efficient, thorough, reliable and simple.

The outer surface of the nozzle may be the outer side of the nozzle. The outer surface and the inner surface of the nozzle may determine the material thickness of the nozzle.

The protrusion can be a protruding part. The protrusion can extend in a radial direction away from the centre axis at the outer surface. In particular, the protrusion can form a shield above the outlet. In particular, the protrusion can be mirror-symmetrical to a plane that runs through the centre of the outlet.

The outlet is arranged in the flat surface, wherein the flat surface exhibits an upper side. The outlet can thus be arranged on the area facing the upper side. The area facing the upper side can be the outlet's limitation that is closest to the upper side. The upper side facing area can extend from the inner surface to the outer surface, wherein the protrusion on the upper side facing area can be arranged on the outer surface.

According to one embodiment, the nozzle can comprise at least one guide element on the outer surface, wherein the at least one guide element can be arranged on a region of the outlet facing one of the opposing sides.

This allows the width of the spray jet to be controlled on one outlet side. Consequently, the spray jet can be better adapted to the surface to be cleaned using the nozzle. This can improve cleaning performance.

The at least one guiding element can be a protruding part. The at least one guiding element can extend in a radial direction away from the centre axis on the outer surface. The at least one guiding element can in particular form a lateral limitation of the outlet.

The outlet is arranged in the flat surface, wherein the flat surface comprises two opposing sides. The area of the outlet facing one of the opposing sides may be the limitation of the outlet, which may be closest to one of the opposing sides. The area facing one of the opposing sides can extend from the inner surface to the outer surface, wherein the at least one guide element can be arranged on the area facing one of the opposing sides on the outer surface.

The at least one guiding element can be connected to the protrusion. For example, the outlet can be partially surrounded by the at least one guiding element and the protrusion, for example in an L-shaped manner.

The at least one guiding element can be configured for the limitation of the fluid jet.

According to one embodiment, the nozzle can comprise two guide elements on the outer surface, wherein the first of the two guide elements can be arranged on the area of the outlet facing the first opposing side, wherein the second of the two guide elements can be arranged on the area of the outlet facing the second opposing side.

In this way, the spray jet can be particularly well directed so that the cleaning performance can be particularly good. In particular, the width of the spray jet can be controlled.

The two guiding elements may be protruding parts. The two guiding elements may extend on the outer surface in a radial direction away from the centre axis. The two guiding elements may in particular form a lateral limitation of the outlet. The two guide elements can be arranged in a particularly mirror-symmetrical manner with respect to a plane that runs through the centre of the outlet. The two guide elements can be arranged on particularly opposing sides of the outlet.

The outlet is arranged in the flat surface, wherein the flat surface comprises two opposing sides. The area of the outlet facing the first opposing side may be the limitation of the outlet, which may be closest to the first opposing side. The area facing the first opposing side can extend from the inner surface to the outer surface, wherein the first of the two guide elements can be arranged on the outer surface at the area facing the first opposing side.

The area of the outlet facing the second opposing side may be the outlet's limitation that is closest to the second opposing side. The area facing the second opposing side may extend from the inner surface to the outer surface, wherein the second of the two guide elements may be arranged on the outer surface at the area facing the second opposing side.

The two guiding elements can be arranged in a mirror-symmetrical manner in a plane, wherein the plane can be aligned in particular perpendicular to the outlet and can include the centre of the outlet.

The two guiding elements can be connected to the protrusion. For example, the outlet can be partially surrounded by the two guiding elements and the protrusion, for example in a U-shaped manner.

The two guide elements can be configured for limitation of the fluid jet.

The two guide elements can extend from the outlet. The distance between the two guide elements can increase with increasing distance from the outlet. The two guide elements can form an angle of 20°-70°, preferably 30°-35°.

According to one embodiment, the radial distance of the flat surface from the centre axis can decrease from a lower side, in particular from a lower side opposing the upper side, towards the upper side.

This way, the pressure in the fluid can be increased, causing the fluid to exit the nozzle at a higher speed. This makes cleaning more efficient, thorough and reliable.

The radial distance from the centre axis can be the radial distance from the longitudinal axis of the nozzle. The centre axis can run centrally through the nozzle. The centre axis can run along the direction of flow of the fluid within the nozzle.

The upper side can be arranged behind the lower side in the direction of flow of the fluid. For example, the fluid could first flow past the lower side and then the upper side. The lower side can be arranged opposite the upper side, in particular along the two opposing sides.

The radial distance of the flat surface from the centre axis can decrease from the lower side to the upper side, which can mean that the flat surface can be tilted towards the centre axis, so that the upper side of the flat surface can be arranged radially closer to the centre axis than the lower side of the flat surface.

According to one embodiment, the flat surface and the protrusion can form an angle of less than 90°.

In this way, a particularly defined spray pattern can be created with at least one spray jet, so that persistent dirt can be removed particularly efficiently, thoroughly, reliably and easily.

The flat surface and the protrusion can form an angle of less than 90°. The angle can be formed by a straight line running through the flat surface and a surface of the protrusion located on the outlet. The surface of the protrusion for determining the angle can be the surface of the protrusion that can come into contact with the fluid.

According to one embodiment, the diameter of the nozzle tapers at least partially along the centre axis in the direction of the upper side.

In this way, the pressure on the fluid can be increased towards the outlet, so that the cleaning power can be increased. This allows particularly efficient, thorough, reliable and easy removal of persistent dirt.

The diameter of the nozzle is the distance between two opposing sides of the inner surface of the nozzle. The diameter can be a straight line connecting two sides of the inner surface and passing through the centre axis.

In the direction towards the upper side, this can mean that the diameter tapers in the direction of flow of the fluid. Taper can mean to reduce, decrease or diminish.

According to one embodiment, the nozzle can exhibit an opposing side to the outlet on the inner surface, wherein the radial distance of the opposing side to the centre axis can decrease in the direction of the upper side, wherein in particular the radial distance can decrease along the centre axis in the direction of the lower side, in front of the outlet, as seen from the upper side.

In this way, the pressure on the fluid can be increased, while at the same time the flow profile at the outlet can remain unchanged. In this way, dirt can be removed reliably, easily, thoroughly and efficiently using the higher pressure. If the radial distance along the centre axis towards the lower side can already be decreased towards the upper side in front of the outlet, an increased pressure on the fluid can be realised over the entire height of the outlet. This makes cleaning even more reliable, easier, more thorough and more efficient.

The side of the inner surface opposing the outlet can be connected to the outlet with an imaginary straight line through the centre axis. The side of the inner surface opposing the outlet can be the rear side of the nozzle.

The radial distance of the opposing side to the centre axis can decrease in the direction of the upper side. For example, the diameter of the nozzle can be reduced by decreasing the radial distance. In the direction of the upper side, it can be along the opposing sides towards the upper side. In the direction of the upper side, it can be in the direction of flow of the fluid.

The outlet can be arranged below the upper side. For example, the outlet can be arranged in the direction of flow along the centre axis in front of the upper side, wherein in particular the outlet can be arranged at a radial distance from the centre axis. The radial distance can therefore already decrease along the centre axis in the direction of the lower side, towards the upper side, in front of the outlet, so that the diameter of the nozzle can already be reduced in front of the outlet.

According to one embodiment, the outlet can be arranged at one end of the nozzle.

In this way, the flow profile can be particularly adapted to the outlet, since no fluid can flow past the outlet. Thus, the cleaning of the sensor can be particularly reliable, thorough, simple and efficient.

The end of the nozzle may be the end of the nozzle. The end of the nozzle may be the end of the spatial extent of the nozzle. Arranged at one end of the nozzle can mean that the outlet may be arranged closer to the end of the nozzle than at the beginning of the nozzle or the middle of the nozzle. The outlet can be spaced apart from the end of the nozzle.

The above-mentioned task is solved according to a second aspect of the invention with a device comprising a sensor, in particular a camera, and a nozzle according to the invention, wherein the nozzle is configured for cleaning the sensor.

The device can be used to easily and reliably remove dirt, especially from a sensor. The device can also be used to easily remove even persistent dirt, ensuring a simple, reliable and thorough removal of dirt. Above all, the device is particularly efficient due to lower fluid consumption.

The above-mentioned task is solved according to a third aspect of the invention by a vehicle, in particular a motor vehicle, with a nozzle according to the invention or a device according to the invention.

The vehicle can be used to easily and reliably remove dirt, especially from a sensor. The vehicle can also easily remove even persistent dirt, ensuring simple, reliable and thorough removal of dirt. Above all, the vehicle is particularly efficient due to lower fluid consumption. Furthermore, driver assistance, semi-autonomous driving or autonomous driving can be ensured.

The above-mentioned task is solved according to a fourth aspect of the invention by using a nozzle according to the invention for cleaning a sensor.

By using the nozzle according to the invention, dirt, in particular on a sensor, can be removed particularly easily and reliably. In this way, even persistent dirt can be easily removed using the nozzle according to the invention, so that a simple, reliable and thorough removal of dirt can be ensured. Above all, the use of the nozzle according to the invention is particularly efficient due to the lower fluid consumption.

Further objects, features, advantages and aspects of the present invention will be appreciated by those skilled in the art from the following description and accompanying claims. However, it should be understood that the following description, accompanying claims and specific examples illustrating preferred embodiments of use are presented only for purposes of illustration. Various changes and modifications within the frame of mind and the scope of the disclosed invention will be readily apparent to those skilled in the art upon reading the following.

### DEFINITIONS

The following terms generally have the meanings set forth below, unless a different meaning is apparent from the context in which they are used.

The term ‘comprise’ when used herein includes and specifically refers to, in addition to its literal meaning, the terms ‘essentially consist of’ and ‘consist of’. Thus, the term ‘comprise’ refers to embodiments in which the subject-matter that ‘comprises’ specifically listed elements does not comprise any further elements, as well as to embodiments in which the subject-matter that ‘comprises’ specifically listed elements may comprise and/or actually comprises further elements. Likewise, the term ‘have’ is to be understood as the term ‘comprise’, which also includes and refers to the terms ‘essentially consist of’ and ‘consist of’. The term ‘consists essentially of’ refers, wherever possible, in particular to embodiments in which the subject-matter comprises, in addition to the specifically listed elements that constitute the subject-matter, 20% or less, in particular 15% or less, 10% or less or, in particular, 5% or less of further elements.

### FIGURES

FIG. 1 schematic view of a nozzle;

FIG. 2 cross-section of a nozzle;

FIG. 3 cross-section of a nozzle;

FIG. 4 schematic view of a nozzle;

FIG. 5 cross-section of a nozzle;

FIG. 6 schematic view of a nozzle;

FIG. 7 cross-section of a nozzle;

FIG. 8 schematic view of a nozzle;

FIG. 9 cross-section of a nozzle.

### SPECIAL DESCRIPTION

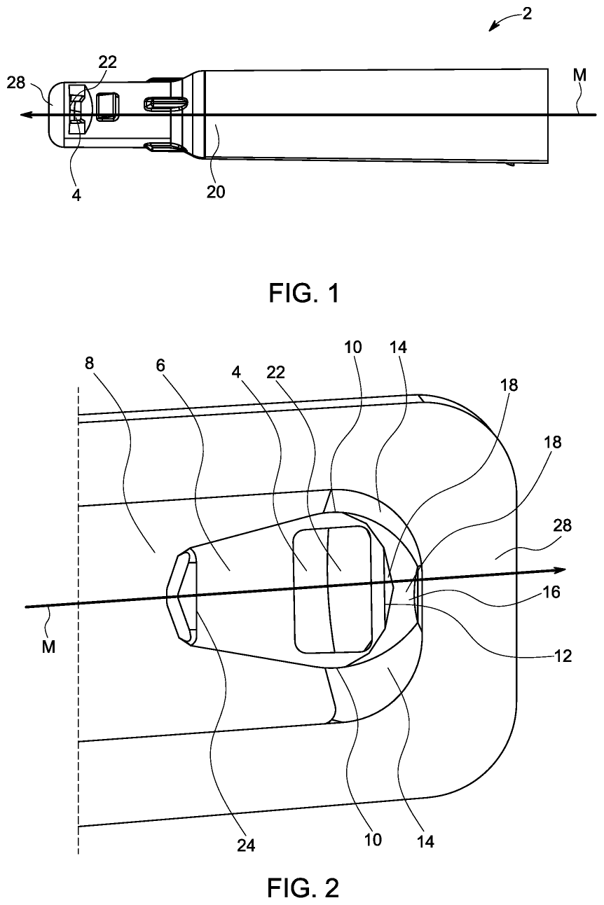

FIG. 1 shows a schematic view of a nozzle 2.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. One of the curved surfaces 14 is arranged on each of the two opposing sides 10 of the flat surface 6, wherein the curved surfaces 14 are configured to converge towards one another in the direction of the upper side 12.

FIG. 2 shows a cross-section of the nozzle 2 shown in FIG. 1.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. One of the curved surfaces 14 is arranged on each of the two opposing sides 10 of the flat surface 6, wherein the curved surfaces 14 are configured to converge towards one another in the direction of the upper side 12.

The outlet 4 and the flat surface 6 of the nozzle 2 are arranged at a radial distance from the centre axis M.

The two curved surfaces 14 are connected via a centre plane 16, wherein the centre plane 16 is arranged on the upper side 12. The centre plane 16 consists of at least two partial planes 18. The curved surfaces 14 start at the flat surface 6 in the area in which the outlet 4 is arranged in the flat surface 6.

The outlet 4 is rectangular. Alternatively, the outlet 4 can be oval or crescent-shaped.

In each case, one point of each of the two curved surfaces 14 is spaced apart a maximum of 0.5 mm, preferably a maximum of 0.1 mm and most preferably a maximum of 0.05 mm from the outlet 4.

The nozzle 2 extends along a centre axis M, wherein the two curved surfaces 14 are arranged mirror-symmetrically to a mirror plane. The mirror plane contains the centre axis M and the mirror plane runs through the centre point of the outlet 4.

The nozzle 2 comprises a protrusion 22 on the outer surface 20, wherein the protrusion 22 is arranged on the area of the outlet 4 facing the upper side 12.

The nozzle 2 is configured to form at least three fluid jets.

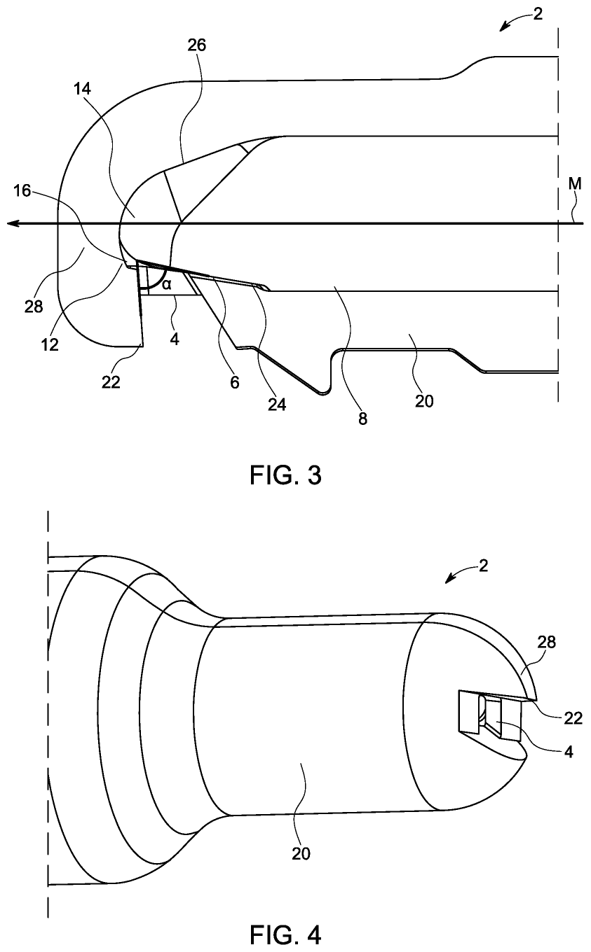

FIG. 3 shows a cross-section of the nozzle 2 shown in FIG. 1.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. Each of the curved surfaces 14 is arranged on one of the two opposing sides 10 of the flat surface 6, wherein the curved surfaces 14 are configured to converge towards one another in the direction of the upper side 12.

The embodiment of nozzle 2 shown in FIG. 3 corresponds to the embodiment of nozzle 2 in FIGS. 1 and 2. Therefore, only the newly shown features will be discussed.

The nozzle 2 comprises a protrusion 22 on the outer surface 20, wherein the protrusion 22 is arranged on the area of the outlet 4 facing the upper side 12.

The radial distance of the flat surface 6 from the centre axis M decreases from a lower side 24 opposing the upper side 12 towards the upper side 12.

The flat surface 6 and the protrusion 22 form an angle α of less than 90°.

The diameter of the nozzle 2 tapers at least partially along the centre axis M in the direction of the upper side 12.

The nozzle 2 exhibits on the inner surface 8 a side 26 opposing the outlet 4, wherein the radial distance of the opposing side 26 to the centre axis M decreases in the direction of the upper side 12. The radial distance decreases already along the centre axis M in the direction of the lower side 24 towards the upper side 12, before the outlet 4.

The outlet 4 is arranged at one end 28 of the nozzle 2.

FIG. 4 shows a schematic view of a nozzle 2, in which the centre axis M runs through the flat surface 6 and the outlet 4, wherein the flat surface 6 and the outlet 4 are perpendicular to the centre axis M.

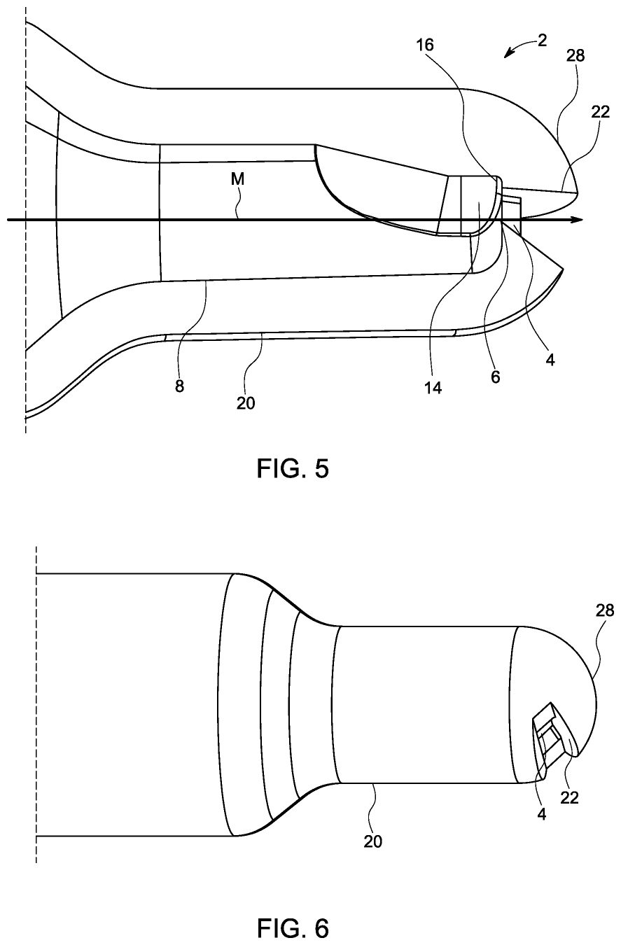

FIG. 5 shows a cross-section of the nozzle 2 shown in FIG. 4.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. Each of the curved surfaces 14 is arranged on one of the two opposing sides 10 of the flat surface 6, wherein the curved surfaces 14 are configured to converge towards one another in the direction of the upper side 12.

The two curved surfaces 14 are connected via a centre plane 16, wherein the centre plane 16 is arranged on the upper side 12. The centre plane 16 consists of at least two partial planes 18. The curved surfaces 14 start at the flat surface 6 in the area in which the outlet 4 is arranged in the flat surface 6.

The outlet 4 is rectangular. A point on each of the two curved surfaces 14 is spaced apart at a maximum distance of 0.5 mm, preferably a maximum of 0.1 mm and most preferably a maximum of 0.05 mm from the outlet 4.

The nozzle 2 extends along a centre axis M, wherein the two curved surfaces 14 are arranged mirror-symmetrical to a mirror plane. The mirror plane contains the centre axis M and the mirror plane runs through the centre of the outlet 4.

Nozzle 2 comprises a protrusion 22 on the outer surface 20, wherein the protrusion 22 is arranged on the area of the outlet 4 facing the upper side 12.

FIG. 6 shows a schematic view of a nozzle 2. The outlet 4 and the flat surface 6 are arranged at a distance from the centre axis M, wherein the flat surface 6 forms an angle greater than 0° and less than 90° with the centre axis M.

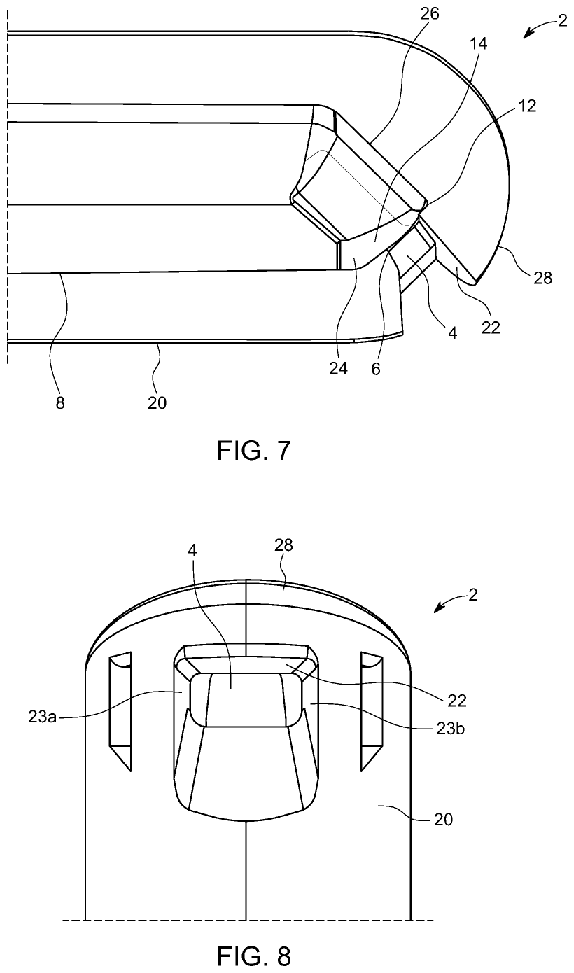

FIG. 7 shows a cross-section of the nozzle 2 shown in FIG. 6.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. Each of the curved surfaces 14 is arranged on one of the two opposing sides 10 of the flat surface 6, wherein the curved surfaces 14 are configured to converge towards one another in the direction of the upper side 12.

The two curved surfaces 14 are connected via a centre plane 16, wherein the centre plane 16 is arranged on the upper side 12. The centre plane 16 consists of at least two partial planes 18. The curved surfaces 14 start at the flat surface 6 in the area in which the outlet 4 is arranged in the flat surface 6.

The outlet 4 is rectangular. A point on each of the two curved surfaces 14 is spaced apart a maximum of 0.5 mm, preferably a maximum of 0.1 mm and most preferably a maximum of 0.05 mm from the outlet 4.

The nozzle 2 extends along a centre axis M, wherein the two curved surfaces 14 are arranged mirror-symmetrical to a mirror plane. The mirror plane contains the centre axis M and the mirror plane runs through the centre of the outlet 4.

The nozzle 2 comprises a protrusion 22 on the outer surface 20, wherein the protrusion 22 is arranged on the area of the outlet 4 facing the upper side 12.

FIG. 8 shows a schematic view of a nozzle 2.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. Each of the curved surfaces 14 is arranged on one of the two opposing sides 10 of the flat surface 6, wherein the curved surfaces 14 are configured to converge towards one another in the direction of the upper side 12.

The nozzle 2 comprises a protrusion 22 on the outer surface 20, wherein the protrusion 22 is arranged on the area of the outlet 4 facing the upper side 12.

The nozzle 2 comprises two guide elements 23a, 23b on the outer surface 20, wherein the first of the two guide elements 23a is arranged on the area of the outlet 4 facing the first opposing side 10. The second of the two guide elements 23b is arranged on the area of the outlet 4 facing the second opposing side 10.

The two guide elements 23a, 23b are arranged mirror-symmetrical to a plane, wherein the plane is aligned perpendicular to the outlet 4 and contains the centre of the outlet 4.

The two guide elements 23a, 23b are connected to the protrusion 22. The two guide elements 23a, 23b are configured for the limitation of the fluid jet.

The nozzle 2 is configured for the formation of at least three fluid jets.

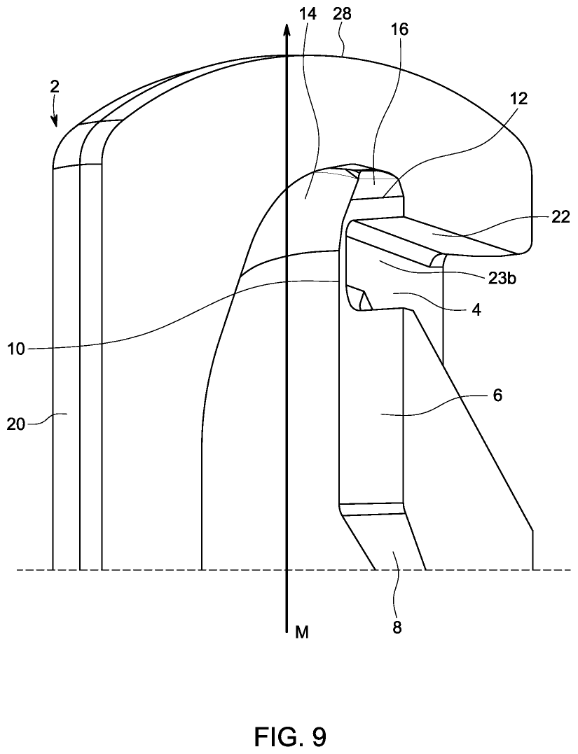

FIG. 9 shows a cross-section of the nozzle 2 shown in FIG. 8.

The nozzle 2 for the automatic cleaning of a sensor, in particular a sensor of a motor vehicle, comprises an outlet 4 for dispensing the fluid. The nozzle 2 comprises a flat surface 6, wherein the flat surface 6 is arranged on the inner surface 8 of the nozzle 2. The outlet 4 is arranged in the flat surface 6. The flat surface 6 comprises two opposing sides 10. The flat surface 6 comprises an upper side 12, wherein the upper side 12 is arranged between the two opposing sides 10. The nozzle 2 comprises two curved surfaces 14 on the inner surface 8. Each of the curved surfaces 14 is arranged on one of the two opposing sides 10 of the flat surface 6, wherein the curved surfaces 14 are configured to converge towards one another in the direction of the upper side 12.

The outlet 4 and the flat surface 6 of the nozzle 2 are arranged at a radial distance from the centre axis M.

The two curved surfaces 14 are connected via a centre plane 16, wherein the centre plane 16 is arranged on the upper side 12. The curved surfaces 14 start at the flat surface 6 in the area where the outlet 4 is arranged in the flat surface 6.

The outlet 4 is rectangular. Alternatively, the outlet 4 can be oval or crescent-shaped.

Nozzle 2 comprises a protrusion 22 on the outer surface 20, wherein the protrusion 22 is arranged on the area of the outlet 4 facing the upper side 12.

The nozzle 2 comprises two guide elements 23a, 23b on the outer surface 20, wherein the first of the two guide elements 23a is arranged on the area of the outlet 4 facing the first opposing side 10. The second of the two guide elements 23b is arranged on the area of the outlet 4 facing the second opposing side 10.

The two guide elements 23a, 23b are arranged mirror-symmetrical to a plane, wherein the plane is aligned perpendicular to the outlet 4 and contains the centre of the outlet 4.

The two guide elements 23a, 23b are connected to the protrusion 22. The two guide elements 23a, 23b are configured for the limitation of the fluid jet.

1. Nozzle for the automatic cleaning of a sensor, in particular a sensor of a motor vehicle, the nozzle comprising:
an outlet for dispensing the fluid, and
a flat surface,
wherein the flat surface is arranged on the inner surface of the nozzle,
wherein the outlet is arranged in the flat surface,
wherein the flat surface comprises two opposing sides,
wherein the flat surface comprises an upper side,
wherein the upper side is arranged between the two opposing sides,
wherein the nozzle comprises two curved surfaces on the inner surface,
wherein each of the curved surfaces is arranged on one of the two opposing sides) of the flat surface,
wherein the curved surfaces are configured to converge towards one another in the direction of the upper side.

2. Nozzle according to claim 1, wherein the two curved surfaces are connected via a center plane,
wherein the center plane is arranged on the upper side.

3. Nozzle according to claim 2, wherein the center plane consists of at least two partial planes.

4. Nozzle according to claim 1, wherein the curved surfaces start at the flat surface in the area where the outlet is arranged in the flat surface.

5. Nozzle according to one of claims claim 1, characterized in that wherein the outlet is rectangular, oval or crescent-shaped.

6. Nozzle according to claim 1, wherein in each case one point of each of the two curved surfaces is at spaced apart a maximum of 0.5 mm from the outlet.

7. Nozzle according to claim 1, wherein the nozzle extends along a center axis,
wherein the two curved surfaces are arranged in a mirror-symmetrical manner with respect to a mirror plane,
wherein the mirror plane contains the center axis and the mirror plane runs through the outlet, in particular through the center of the outlet.

8. Nozzle according to claim 1, wherein the nozzle comprises a protrusion on the outer surface,
wherein the protrusion is arranged on the area of the outlet facing the upper side.

9. Nozzle according to claim 7, wherein the radial distance of the flat surface to the center axis decreases from a lower side, in particular the lower side opposing the upper side, towards the upper side.

10. Nozzle according to claim 8, wherein the flat surface and the protrusion form an angle of less than 90°.

11. Nozzle according to claim 7, wherein the diameter of the nozzle tapers at least partially along the center axis in the direction of the upper side.

12. Nozzle according to claim 7, wherein the nozzle exhibits on the inner surface a side opposing the outlet,
wherein the radial distance of the opposing side from the centre center axis decreases in the direction of the upper side,
wherein the radial distance along the center axis in the direction of the lower side decreases in front of the outlet when viewed from the upper side.

13. Nozzle according to claim 1, wherein the outlet is arranged at one end of the nozzle.

14. Device comprising a sensor, in particular a camera, and a nozzle according to claim 1, wherein the nozzle is configured for cleaning the sensor.

15. A vehicle, in particular a motor vehicle, having a nozzle according to claim 1.

16. A vehicle, in particular a motor vehicle, having a device according to claim 14.
